(19) United States
(12) Patent Application Publication
(10) Pub. No.: US 2005/0006379 A1
(43) Pub. Date: Jan. 13, 2005

(54) Invisable stove top

(76) Inventor: Steven Leo Sullivan, Potomac Falls, VA (US)

Correspondence Address: Steven Sullivan, 268 Terrie Dr., Potomac Falls, VA, 20165, US

(21) Appl. No.: 10/613,049

(22) Filed: Jul. 7, 2003

(51) Int. Cl. H05B 6/12

(52) U.S. Cl. 219/620

(57) ABSTRACT

The present invention relates to a unique arrangement of induction heating elements with surface top materials creating an aesthetically pleasing cook top area. More specifically it relates to the integration of electric induction coils with a decorative high heat surface top such as granite, slate, concrete, Silestone, Zodiac or other suitable decorative surface and a method for properly identifying the cook top area.

### FIELD OF THE INVENTION

The present invention relates to the integration of an electric induction coil with a suitable surface top material such as to produce a continuous and/or seamless flat top surface, which would be deemed aesthetically pleasing to the eye.

### BACKGROUND OF THE INVENTION

Previously developed induction cook tops use a cook top material such as ceramic and/or glass surface top material. This creates a discontinuity in the aesthetics of surface top area. The advantage of using such a new integration method would be that there would be no need for discontinuity of the top surface aesthetics with the added benefit of a continuous and/or seamless flat top surface with the cook top being invisible; except for the markings and/or material or lighting that would be provided in order to identify the cooking area.

There is no need for heat-permeable material or a thermally conductive surface top material when using induction type of heating elements. The use of heat-permeable materials is sited within the current U.S. Pat. No. 6,236,024. There is a lacking in the current state of the art in the use of other surface top materials, which are stable and/or resistant to the presence of high heat from cookware with induction type of heating elements, which would include the use of heat resistant materials such as Stone, Slate, Granite, Silestone, Zodiac and/or other suitable materials in the area of cook top design.

### OBJECT OF THE INVENTION

The object of the invention is to properly arrange a cooking area and exactly position that area where desired, thus increasing the versatility and aesthetics of the cook top area. The placement of the induction heating element or elements under a granite surface or other suitable decorative surface top material substantially eliminates the disadvantages and weaknesses of the constructs and embodiments of other cook tops and provides for a more aesthetically pleasing installation with the added benefit of a more versatile cook top area.

Another object is to provide a means of maintaining a much cooler surface top area where the induction elements are active by means of using an insulator in said active area to greatly reduce the amount of heat that is propagated from the cookware used into the surface area below and surrounding said cookware.

A further object is to provide a means of indication that the cook top surface area is hot by means of using thermochromatic polymers or projected lighting, which may be decorative, and/or letters or symbols.

### SUMMARY OF THE INVENTION

The present invention relates to the placement of induction heating elements under the chosen surface area to create and arrange a cook top area, which is placed where desired which may be constructed into a seamless environment.

As a result of this arrangement claimed it becomes possible to substantially eliminate the cutting needed to install drop-in inductive heating elements but which does not preclude such cutting for inserting decorative Granite with differing colors and/or materials which mayor may not be flush with the surrounding surface area.

The method of positioning the identifying cook top area and attaching the induction coils to the under side of the counter top may be accomplished in several ways a few of which will be described. The most effective means of determining the exact position that needs to be identified as the cook top element area is by using flux paper or other visual aid which will identify the exact position of the active magnetic flux field areas thus allowing for exact placement of the markings and/or material or projected light for identifying the stove top elements.

Attachment of the induction elements may be accomplished by means of a sliding track, which is attached to said induction elements, which may be used that would allow for easy replacement of the induction coils if such a need arises. The track maybe mounted to the underside of the top surface or it may be mounted to the lower support structure such as the surrounding cabinet or to the floor directly by means of a suitable extension or support material.

Attachment of the induction elements may be accomplished by means of a mechanical screw type attachment which may use a suitable insert material placed into the surface material from the under side, or a slotted rail maybe used which would be similar to the sliding track in functionality but with a simple slotted drawer type of design. Another possible method of attachment would be through the use of a suitable adhesive material.

### BRIEF DESCRIPTION OF THE DRAWINGS

The invention is explained in greater detail below with reference to the exemplary embodiments that are illustrated in the accompanying figures.

FIG. 1 is a bottom up view of one possible implementation of the concept.

FIG. 2 is a side view of FIG. 1.

### DESCRIPTION OF THE PREFERRED EMBODIMENT

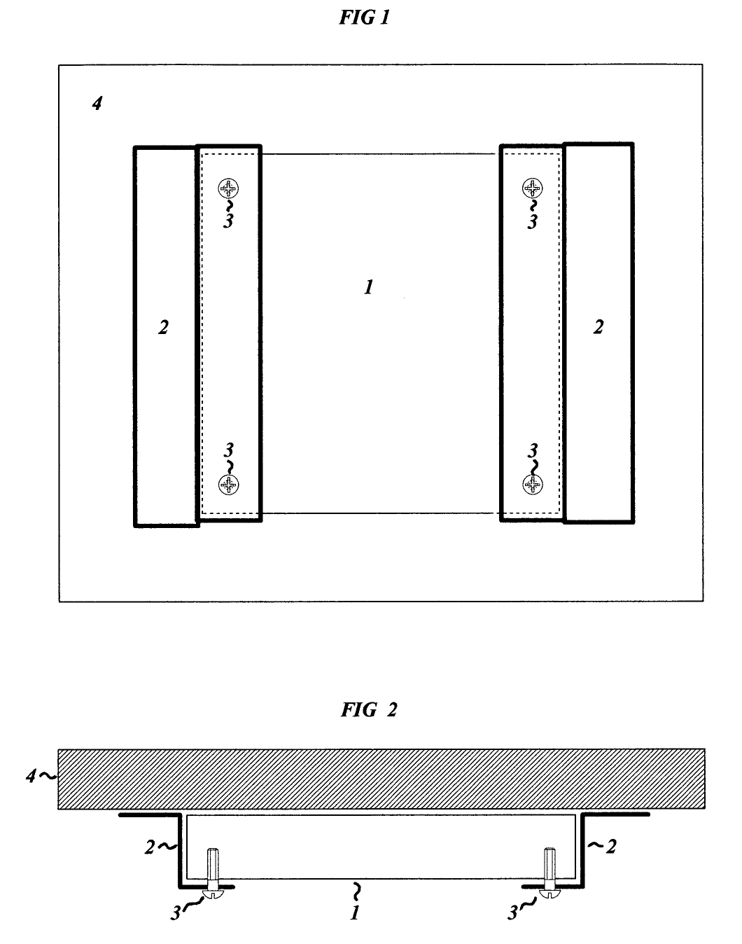

FIG. 1 shows a bottom up view of an arrangement of one inductive heating element placed under a granite counter top surface.

FIG. 2 shows a side view of FIG. 1.

4 is the granite counter top or other suitable surface and 1 is the induction heating element with 2 being the support members which holds the weight of the induction element which is attached to the granite surface by means of an adhesive material not shown with mounting screws 3 used to physically secure the induction heating element to the support members 2.

The details in the patents, patent applications and publications may be considered to be incorporable, at applicant's option, into the claims during prosecution as further limitations in the claims to patentability distinguished from any amended claims from any prior art.

Although only a few exemplary embodiments of this invention have been described it in no way limits the scope within this invention, those skilled in the art will readily appreciate that any modifications are possible and are to be included within the scope of this invention as defined in the following claims. In the claims means and function clause are intended to cover the structural concepts described herein as performing the recited function and not only structural equivalents but also equivalent structures.

The invention as described herein above in the context of the preferred embodiments is not to be taken as limited to all of the provided details thereof, since modifications and variations thereof may be made without departing from the spirit and scope of the invention.

1. An arrangement of induction heating elements such that the induction heating element is mounted or placed underneath a continuous granite surface or other suitable high heat surface top material thus substantially simplifying installation in a seamless manner.

2. A seamless cook top or cooking area, which may be defined by placement of markings and/or material, and/or projected lighting of that area by use of various means.

3. As per claim 1 in which the attachment or mounting means is defined to incorporate the use of a mechanical screw type attachment which may use a suitable insert material within the underside of said surface material in order to accommodate mounting screws.

4. As per claim 1 in which the attachment or mounting means is defined to be a sliding track, which would allow for easy replacement of the induction coils if such a need arises. The track may be mounted to the underside of the top surface or to any other suitable support structure.

5. As per claim 1 in which the attachment or mounting means is defined to be a slotted rail which would be similar to the sliding track in functionality but with a simple slotted drawer type of design which maybe mounted to the underside of the top surface or to any other suitable support structure.

6. As per claim 1 in which the attachment or mounting means is defined to be through the use of a suitable adhesive material applied to the under side of said surface material.

7. As per claim 1 in which the attachment or mounting means is defined to be the use of spring clips which would be attached to the under side of the surface top and provide a tight contact between the induction element and the underside of the cook top surface

8. A cook top as per claim 2 wherein the cooking area is defined by a decorative insert of granite or other suitable material which may or may not be of a differing color which may or may not be flush to the surrounding surface top area which may or may not be an insulator material.

9. A cook top as in claim 3 wherein the use of inserts is replaced by the use of a suitable adhesive and a mounting material or bracket as in FIG. 1 which is then mechanically attached to the induction element using screws.

10. As per claim 1 wherein the placement of the induction element is provided by a support pedestal or shelf which is mechanically secured to the floor or cabinet and the induction element is secured to the shelf or pedestal by mechanical means or by the use of an adhesive.

11. An arrangement of induction heating elements such that in an installation there may be a Granite top or other suitable decorative high heat material used in a drop-in configuration, thus there would be a Granite surface or other suitable decorative surface top material which mayor may not be of a high heat material which is cut out in order to accommodate the drop-in induction coils which would also have a Granite surface and/or other suitable high heat decorative surface material which mayor may not be of a differing color and which may or may not be flush with the surrounding Granite surface or other suitable decorative surface top material.

12. A method of installation which would allow for proper placement of the stove top markings of the stove top elements is provided for by the use of flux paper or other suitable visual indication which would directly identify the exact location of the active magnetic flux field areas thus allowing for exact placement of the markings and/or material or projected lighting identifying the stove top elements.

13. The use of thermochromatic polymers in the marking and/or material or projected light, which may be of a certain color identifying the heat surface area providing a visual indication as to any residual heat or active heat that may be present.

14. As per claim 13 wherein the thermochromatic polymer or projected lighting is used to reveal or hide the word HOT or any other word, letters, symbol, design or logo in the heat surface area of various languages which is dependent upon temperature.

15. As per claim 2 wherein the markings and/or material is an insulator material which may or may not be thermochromatic such that the cookware used is prevented from being in direct physical contact with the surface top material thus preventing the transfer of thermal energy from said cookware into the surface top material under the cookware and the surrounding area thus providing for a much cooler surface top area.

16. As per claim 8 wherein the markings and/or material is an insulator material which may or may not be thermochromatic such that the cookware used is prevented from being in direct physical contact with the surface top material thus preventing the transfer of thermal energy from said cookware into the surface top material under the cookware and the surrounding surface top area thus providing for a much cooler surface top area.

17. As per claim 2 in which the markings are in brail.

18. As per claim 1 wherein a grate top material is used such as steel which would be caused to heat up when placed on the active induction heat top area or cook top surface thus providing for a grilling means on the cook top surface.

19. As per claim 1 wherein a solid top material is used such as steel which would be caused to heat up when placed on the active induction heat top area or cook top surface thus providing for a means of using cookware which do not work well with induction type heating elements such as aluminum on the cook top surface.

20. As per claim 19 wherein the solid material, which may or may not use a thermochromic material, is insulated from the surface top area by use of an insulator material.

21. As per claim 18 wherein the solid material, which may or may not use a thermochromic material, is insulated from the surface top area by use of an insulator material.
